(19) United States
(12) Patent Application Publication
(10) Pub. No.: US 2011/0276818 A1
(43) Pub. Date: Nov. 10, 2011

(54) POWER CONSUMPTION QUANTITY ESTIMATION SYSTEM

(75) Inventors: Masatoshi Yamamoto, Kahoku-shi (JP); Masaki Matsuda, Kahoku-shi (JP)

(73) Assignee: PFU LIMITED, Kahoku-shi (JP)

(21) Appl. No.: 12/938,434

(22) Filed: Nov. 3, 2010

(30) Foreign Application Priority Data
May 10, 2010 (JP) 2010-108218

(51) Int. Cl. G06F 1/00

(52) U.S. Cl. 713/340

(57) ABSTRACT

A power consumption quantity estimation system 100 includes: a power consumption coefficient retaining unit 203 to previously retain a power consumption coefficient indicating a level of power consumption per operating status of a device 3; a communication acquiring unit 102 to acquire a communication related to the device 3 connected to a network; an operating status acquiring unit 104 to acquire the operating status of the device 3 by analyzing the acquired communication; a power consumption coefficient acquiring unit 203 to acquire the power consumption coefficient, related to the operating status, of the device 3 in the power consumption coefficients retained by the power consumption coefficient retaining unit 203; and an estimated power consumption quantity calculating unit 204 to calculate estimated power consumption quantity of the device 3 during a target period by use of the power consumption coefficient per operating status during the target period.

This application is based upon and claims the benefit of priority of the prior Japanese Patent Application No. JP2010-108218, filed on May 10, 2010, the entire contents of which are incorporated herein by reference.

### FIELD

The present invention relates to a technology for calculating a power consumption quantity of a device.

### BACKGROUND

Technologies (refer to Japanese Patent Publication No. 4385092, Japanese Patent Laid-Open Publication No. 2007-65255 and Japanese Patent Laid-Open Publication No. 2007-79754) have hitherto existed, which serve to calculate a power consumption of a device by use of an electric power quantity sensor etc. Further, there is a power monitoring system (refer to Japanese Patent Laid-Open Publication No. 2007-33138) including a device which consumes the electric power, a power monitoring terminal which monitors a power consumption quantity of the device, and a control device which controls the device, calculates an estimated power consumption quantity of the device on the basis of control information in the device and transmits the estimated power consumption quantity to the power monitoring terminal via a network; and a power consumption monitoring device (refer to Japanese Patent Laid-Open Publication No. 2009-159712) also exists, which acquires load information indicating a processing load on an electric device from the electric device connected via the network and estimates the power consumption of the electric device on the basis of collected pieces of load information.

Measurement and collection of the power consumption quantities in an office have hitherto involved using a method of measuring and collecting information on the electric power of target devices by employing the electric power quantity sensor etc and a method of installing a dedicated application into the target device such as a personal computer and thus collecting the information on the electric power.

The conventional methods, however, entail changing an existing system architecture such as installing the electric power sensor and the dedicated application and have occurrence of costs for manpower and equipment. Further, these methods are capable of measuring and collecting the power consumptions of only the target devices equipped with the electric power sensors or the target devices into which the dedicated applications are installed, i.e., the target devices recognized as power consumption measuring target devices by an administrator.

Moreover, a technology of estimating the power consumption based on the control information set in the target device and the load information acquired from the target device in a management device for managing the target device, is considered as a technology of acquiring the power consumption of the target device without adding any new hardware such as the electric power sensor. Even the case of employing the power consumption estimation technology such as this, however, requires a mechanism used for the management device to manage or control the target device, and merely a device managed or controlled by the management device can be the target device of estimation of the power consumption. Moreover, the power consumption estimation technology such as this does not solve the problem that the power consumption of only the target device recognized by the administrator can be acquired.

In view of the problems given above, an object of the present invention is, calculating and collecting the power consumptions of the target devices without installing any special mechanisms for measuring the power consumption into the target devices.

### SUMMARY

The present invention adopts the following means in order to solve the problems given above. Namely, the present invention is a power consumption quantity estimation system including: a power consumption coefficient retaining unit to previously retain a power consumption coefficient indicating a level of power consumption per operating status of a device; a communication acquiring unit to acquire a communication related to the device connected to a network; an operating status acquiring unit to acquire the operating status of the device by analyzing the communication acquired by the communication acquiring unit; a power consumption coefficient acquiring unit to acquire the power consumption coefficient, related to the operating status, of the device in the power consumption coefficients retained by the power consumption coefficient retaining unit; and an estimated power consumption quantity calculating unit to calculate estimated power consumption quantity of the device during a target period by use of the power consumption coefficient per operating status during the target period for calculating the power consumption quantity.

Herein, the operating status is a status as to whether the device operates or not (power ON/OFF) and whether the load is high or low. Further, the power consumption coefficient is a coefficient indicating a magnitude of the power consumption of the device and is, according to the present invention, determined and previously retained per operating status of the device. Then, in the power consumption quantity estimation system according to the present invention, the power consumption coefficient corresponding to the operating status of the device is acquired from the power consumption coefficients retained beforehand by the power consumption coefficient retaining unit, and the estimated power consumption quantity of the device is calculated. If the target device is a device of which the operating status can not be acquired from outside, however, it is difficult to acquire the operating status of the device without installing any special mechanism (the electric power sensor, the dedicated application, etc) for measuring the power consumption into the target device. Such being the case, in the power consumption quantity estimation system according to the present invention, the operating status of the device is acquired by obtaining the communication related to the device and analyzing the obtained communication.

Further, the communication acquired by the communication acquiring unit is analyzed by a variety of methods, and the operating status of the device may be thus acquired. For example, according to the present invention, the operating status acquiring unit, when the communication acquiring unit acquires the communication of which a sender is the device, may acquire the operating status indicating that the device is in operation.

Moreover, for instance, according to the present invention, the operating status acquiring unit may acquire the operating status containing a magnitude of the load on the device, corresponding to a quantity or a content of the communication acquired by the communication acquiring unit, and the power consumption coefficient acquiring unit may acquire the power consumption coefficient corresponding to the magnitude of the load, related to the operating status, of the device.

Further, the power consumption quantity estimation system according to the present invention may further include an operating time acquiring unit to acquire operating time, per operating status, of the device, wherein the estimated power consumption quantity calculating unit may calculate the estimated power consumption quantity of the device during the target period by use of the power consumption coefficient per operating status during the target period and the operating time per operating status during the target period.

The operating time per operating status is acquired, and the estimated power consumption quantity is calculated by taking account of the operating time per operating status, whereby the more precise estimated power consumption quantity can be calculated even in the case of including the plurality of operating statuses in the target period for calculating the power consumption quantity.

Still further, in the present invention, the power consumption coefficient may be a power consumption quantity, per unit time related to the operating status, of the device, and the estimated power consumption quantity calculating unit may calculate the estimated power consumption quantity of the device during the target period by multiplying the power consumption coefficient per operating status during the target period by the operating time per operating status during the target period.

The power consumption quantity per unit time is employed as the power consumption coefficient, whereby the estimated power consumption quantity in the operating status as the calculation target can be calculated simply by multiplying the power consumption coefficient related to the operating status by the operating time.

Yet further, the power consumption quantity estimation system according to the present invention may further include: a device detecting unit to detect the device connected to the network; and a device type determining unit to determine the device type of the detected device, wherein the power consumption coefficient retaining unit may previously retain the power consumption coefficient per operating status on a per-device-type basis, and the power consumption coefficient acquiring unit may acquire the power consumption coefficient, related to the operating status, of the device in accordance with the device type of the device that is determined by the device type determining unit.

Herein, the device type is information indicating a category enabling distinction between an application, a function or performance of the target device such as indicating which category, a personal computer or a router or a server the target device belongs to, and indicating, if being the server, what type of a service the server provides, and further indicating, more minutely, which vendor this server is provided by and what type this server is of. Actually, a tendency of the power consumption of the device is different depending on the device type as well as on the operating status. According to the present invention, the more accurate estimated power consumption quantity can be calculated by determining the device type and acquiring the power consumption coefficient matching with conditions of both of the device type and the operating status.

Still yet further, in the present invention, the device type determining unit may determine the device type of the device detected by the device detecting unit in a way that extracts information on the device that is contained in the communication acquired by the communication acquiring unit or determines a type of the communication acquired by the communication acquiring unit.

Especially, according to the type of the communication acquired by the communication acquiring unit, an application of the device can be grasped. Hence, according to the present invention, even when the device type can not be acquired directly from the communication content etc, the device type is presumed from the application of the device and thus determined, which contributes to calculate the precise estimated power consumption quantity.

Moreover, in the present invention, the power consumption quantity estimation system may further include, with the estimated power consumption quantity calculating unit calculating the estimated power consumption quantity per device with respect to the plurality of devices connected to the network, an estimated power consumption quantity totalizing unit to calculate a total of the estimated power consumption quantities of the devices connected to the network by totalizing the estimated power consumption quantities per device, which are calculated by the estimated power consumption quantity calculating unit.

The estimated power consumption quantities calculated per device are totalized, and the total of the estimated power consumption quantities of the devices connected to the network is calculated, thereby facilitating the management of the power consumption quantities in the whole network.

Furthermore, the present invention may also be grasped by way of the invention of an information processing device used in the power consumption quantity estimation system. For example, the present invention is an information processing device connected to a server device including: a power consumption coefficient retaining unit to previously retain a power consumption coefficient indicating a level of power consumption per operating status of a device; a power consumption coefficient acquiring unit to acquire the power consumption coefficient, related to the operating status, of the device in the power consumption coefficients retained by the power consumption coefficient retaining unit; and an estimated power consumption quantity calculating unit to calculate estimated power consumption quantity of the device during a target period by use of the power consumption coefficient per operating status during the target period for calculating the power consumption quantity, the information processing device including: a communication acquiring unit to acquire a communication related to the device connected to a network; an operating status acquiring unit to acquire the operating status of the device by analyzing the communication acquired by the communication acquiring unit; and a transmitting unit to transmit the operating status acquired by the operating status acquiring unit to the server device.

Additionally, the present invention may further be grasped by way of the invention of a server device in the power consumption quantity estimation system. For example, the present invention is a server device connected to an information processing device including: a communication acquiring unit to acquire a communication related to the device connected to a network; and an operating status acquiring unit to acquire the operating status of the device by analyzing the communication acquired by the communication acquiring unit, the server device including: a receiving unit to receive the operating status acquired by the operating status acquiring unit from the information processing device; a power consumption coefficient retaining unit to previously retain a power consumption coefficient indicating a level of power consumption per operating status of a device; a power consumption coefficient acquiring unit to acquire the power consumption coefficient, related to the operating status, of the device in the power consumption coefficients retained by the power consumption coefficient retaining unit; and an estimated power consumption quantity calculating unit to calculate estimated power consumption quantity of the device during a target period by use of the power consumption coefficient per operating status during the target period for calculating the power consumption quantity.

Further, the present invention can be also grasped by way of a method executed by a computer or a program to make the computer execute the method. Moreover, the present invention may also be a recording medium recorded with this program, which can be read by the computer, other devices and machines. Herein, the recording medium readable by the computer etc connotes a recording medium capable of storing information such as data and programs electrically, magnetically, optically, mechanically or by chemical action, which can be read from the computer etc.

According to the present invention, the power consumptions of the target devices can be calculated and collected without installing any special mechanisms for measuring the power consumptions into the target devices.

### BRIEF DESCRIPTION OF THE DRAWINGS

FIG. 1 is a diagram illustrating architecture of a whole power consumption quantity estimation system according to an embodiment;

FIG. 2 is a diagram illustrating hardware configurations of a monitoring device and an information aggregation server device according to an embodiment;

FIG. 3 is a diagram illustrating functional configurations of the monitoring device and the information aggregation server device according to an embodiment;

FIG. 4 is a flowchart illustrating a flow of a power consumption quantity estimation process according to the embodiment; and

FIG. 5 is a diagram illustrating a variation of the architecture of the power consumption quantity estimation system.

### DESCRIPTION OF EMBODIMENTS

An embodiment of a power consumption quantity estimation system 100 according to the present invention will hereinafter be described with reference to the drawings. It should be noted that the embodiment, which will hereinafter be discussed, represents one example in the case of carrying out the present invention, and the present invention is not limited to a specific configuration that will be described below. On the occasion of carrying out the present invention, it is preferable to properly adopt a specific configuration corresponding to the embodiment.

<Configuration>

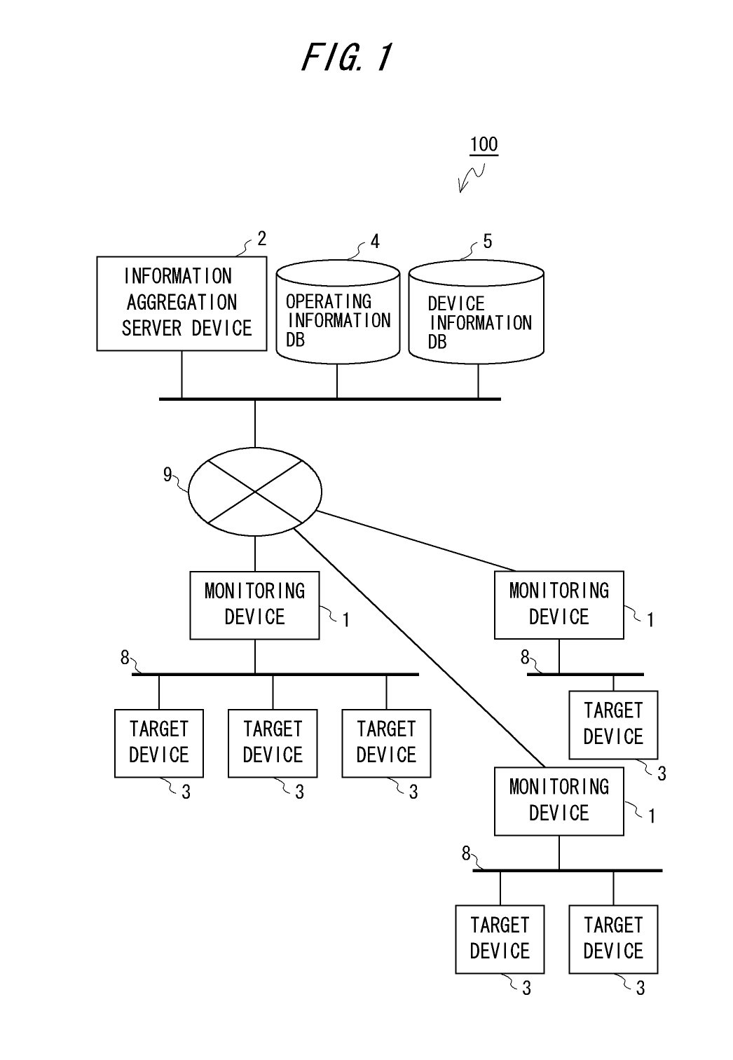

FIG. 1 is a diagram illustrating a configuration of the power consumption quantity estimation system 100 as a whole according to the embodiment. The power consumption quantity estimation system 100 is a system in which monitoring devices 1 are connected via a network 9 such as the Internet to an information aggregation server device 2. Further, devices such as personal computers (which will hereinafter be abbreviated to the [PCs]), servers, network printers, network scanners and KIOSK terminals are connected to the monitoring devices 1 via base-point networks (segments) 8 such as LANs (Local Area Networks). In the embodiment, these devices connected to the base-point network 8 are target devices 3 becoming power consumption quantity estimation target devices of the power consumption quantity estimation system 100. Further, the base-point network 8 to which the target devices 3 are connected may involve adopting networks based on a variety of standards such as IEEE802.3 and FDDI (Fiber-Distributed Data Interface).

The power consumption quantity estimation system 100 may be realized by a single device and may also be realized in the way of sharing respective functions provided in the power consumption quantity estimation system 100 with two or more devices. In the embodiment, the power consumption quantity estimation system 100 is realized by the monitoring devices 1 and the information aggregation server device 2, which are connected to each other via the network 9. Namely, in the embodiment, the monitoring device 1 corresponds to an information processing device according to the present invention, and the information aggregation server device 2 corresponds to a server device according to the present invention. The monitoring device 1 acquires information by monitoring the target devices 3 connected to the base-point network 8 and transmits the acquired information to the information aggregation server device 2. The information aggregation server device 2 calculates, based on the information received and thus collected from the monitoring devices 1, an estimated power consumption quantity of each of the target devices 3. On the occasion of carrying out the present invention, however, the respective functions for carrying out the present invention may be provided in the system on the whole, and the embodiment, which will hereinafter be discussed, does not limit devices or units that execute these functions. For example, in the embodiment, the respective functions executed by the monitoring devices 1 and the information aggregation server device 2 may be shared otherwise corresponding to the embodiment and may also be all executed by the monitoring devices 1. For example, the embodiment takes, it is considered, such a variation that an operating time acquiring unit 105, which will be described later on, provided in the monitoring device 1 is included in the server device.

Note that as illustrated in FIG. 1, the monitoring device 1 may be installed in each of a plurality of base-point networks. A configuration of installing the monitoring devices 1 in the plurality of base-point networks enables the information aggregation server to aggregate the operating statuses of the target devices 3 in the plurality of base-point networks and enables the power consumption to be managed in a way that covers the plurality of base-point networks.

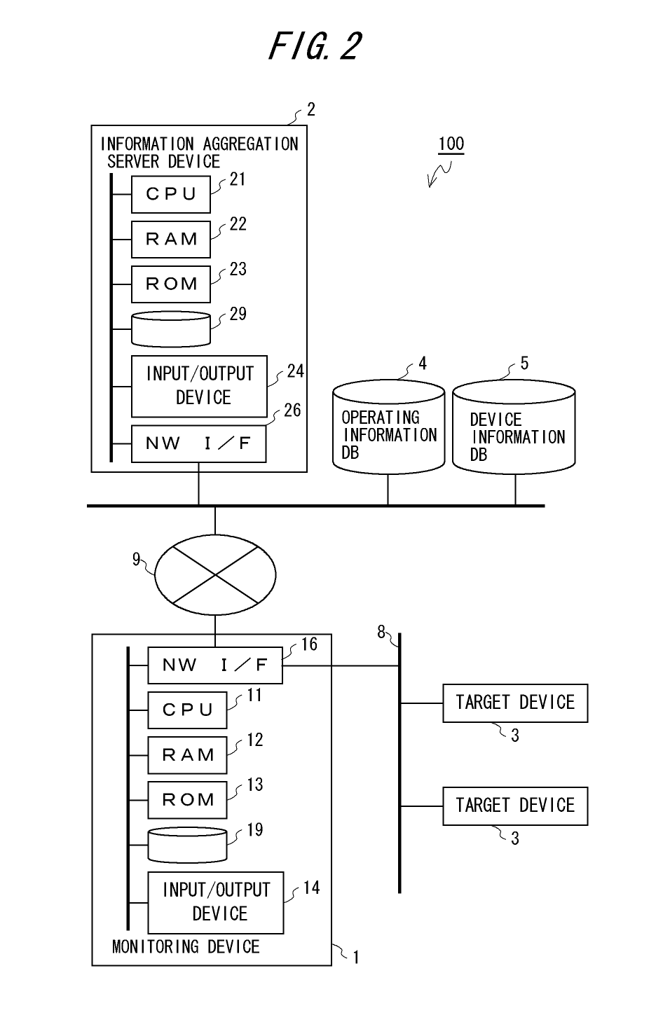

FIG. 2 is a diagram illustrating hardware configurations of the monitoring device 1 and the information aggregation server device 2 according to the embodiment. Both of the monitoring device 1 and the information aggregation server device 2 are computers constructed by electrically connecting CPUs (Central Processing Units) 11, 21, RAMs (Random Access Memories) 12, 22, ROMs (Read Only Memories) 13, 23, input/output devices 14, 24 such as a display, a mouse and a keyboard, network interfaces 16, 26 and auxiliary storage devices 19, 29. The auxiliary storage device 19 can involve using, e.g., an EEPROM (Electrically Erasable Programmable ROM), an HDD (Hard Disk Drive) and an SSD (Solid State Drive) etc.

The CPUs 11, 21 are central processing units and process instructions and data deployed on the RAMs 12, 22, thereby controlling the RAMs 12, 22, the auxiliary storage devices 19, 29, the input/output devices 14, 24, etc. The RAMs 12, 22 are main storage devices, controlled by the CPUs 11 and 21, to and from which the variety of instructions and data are written and read. The auxiliary storage devices 19, 29 are nonvolatile storage devices to and from which to write and read want-to-retain information even when mainly the monitoring devices 1 and the information aggregation server device 2 are powered off. Contents inputted from the input device are recorded on the RAMs 12, 22 and are processed by the CPUs 11, 21.

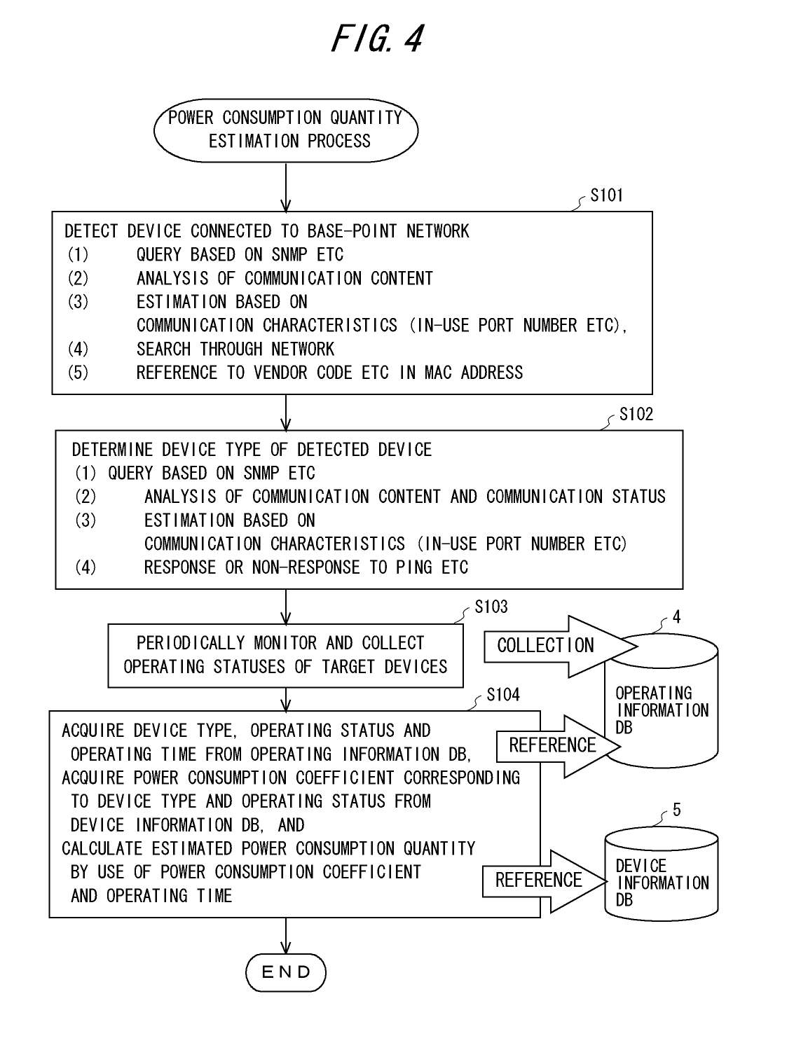

The auxiliary storage devices 19, 29 are stored with various items of data used by the monitoring devices 1 or the information aggregation server device 2 in addition to an OS (Operating System) of each of the monitoring devices 1 or the information aggregation server device 2, which is loaded into the RAM 12 or 22, and a variety of programs for executing the processes illustrated in a flowchart of FIG. 4, which is loaded into the RAM 12 or 22.

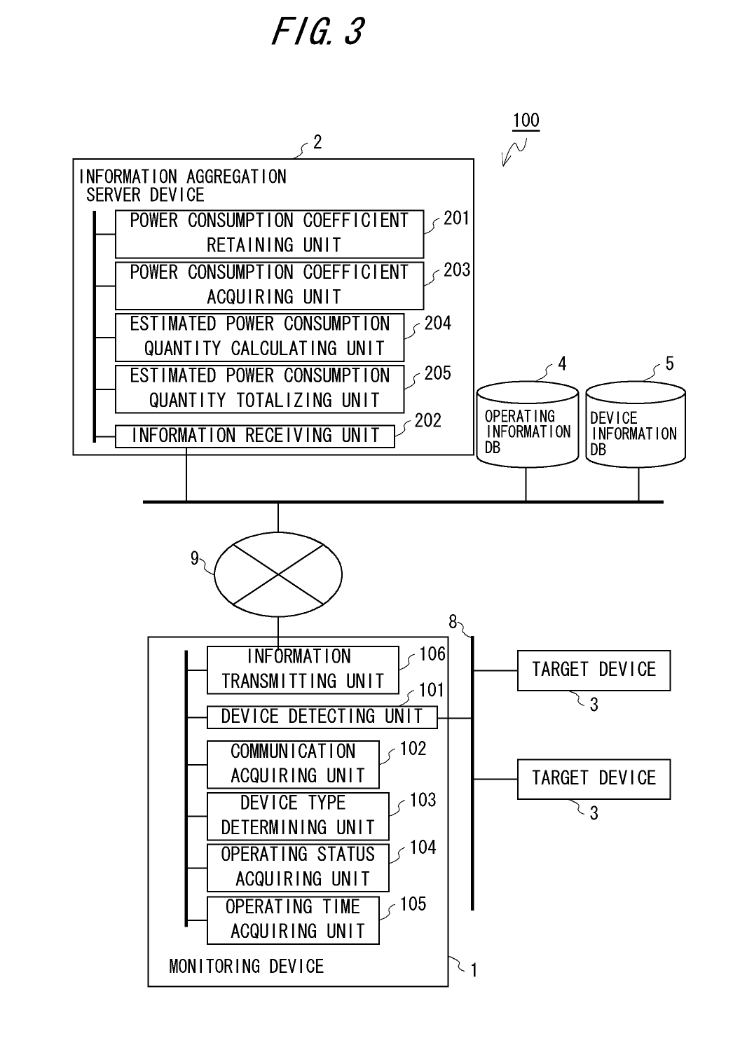

FIG. 3 is a diagram illustrating functional configurations of the monitoring device 1 and the information aggregation server device 2 according to the embodiment. The CPU 11 interprets and executes the variety of programs deployed on the RAM 12, whereby the monitoring device 1 according to the embodiment functions as an information processing device including a device detecting unit (module) 101, a communication acquiring unit (module) 102, a device type determining unit (module) 103, an operating status acquiring unit (module) 104, an operating time acquiring unit (module) 105 and an information transmitting unit (module) 106. These function units execute functions corresponding to respective means provided in the power consumption quantity estimation system according to the present invention. Further, the embodiment discusses an example in which each of these functions is executed by the general-purpose CPU 11, however, a part or the whole of these functions may be realized by one dedicated processor or a plurality of dedicated processors.

Moreover, the CPU 21 interprets and executes the variety of programs deployed on the RAM 22, whereby the information aggregation server device 2 according to the embodiment functions as a server device including a power consumption coefficient retaining unit (module) 201, an information receiving unit (module) 202, a power consumption coefficient acquiring unit (module) 203, an estimated power consumption quantity calculating unit (module) 204 and an estimated power consumption quantity totalizing unit (module) 205. These function units execute functions corresponding to the respective means provided in the power consumption quantity estimation system according to the present invention. Further, the embodiment discusses an example in which each of these functions is executed by the general-purpose CPU 21, however, a part or the whole of these functions may be realized by one dedicated processor or a plurality of dedicated processors.

Herein, the power consumption coefficient retaining unit 201 previously retains, on a per-device-type basis, a power consumption coefficient representing a level of the power consumption in every operating status of the device. This is because a tendency of the power consumption is different depending on the device type and is, even when the device type is the same, different on a per-operating-status basis such as [in-operation] status, a [non-operation] status, an [in-operation-with-high-load] status and [in-operation-with-low-load] status. Note that the power consumption quantity per unit time related to the operating status of the device is retained as the power consumption coefficient in the embodiment.

Moreover, an operation information database 4 and a device information database 5 are connected to the information aggregation server device 2. The operation information database 4 and the device information database each retain the information used for the variety of processes executed in the power consumption quantity estimation system 100. To be specific, the operation information database 4 retains items of information (the device type, a host name, an IP address, etc) of the detected device and items of operation information (the operating time, the operating statue) of the device. Further, the device information database 5 previously retains the device type information and the power consumption coefficients according to the device type/operating status. Note that the power consumption coefficient may be set individually per detected target device 3. In the case of conducting the individual setting, an administrator may manually set the power consumption coefficient per d target device 3.

<Details of Processes>

FIG. 4 is a flowchart illustrating a flow of the power consumption quantity estimation process according to the embodiment. The process given in the flowchart is periodically executed by the monitoring device 1 and the information aggregation server device 2 or executed as triggered by en event that the monitoring device 1 detects the connection or disconnection of the target device 3. Note that a specific content and a specific sequence of the process given in the flowchart are each one example, and the content and the sequence suited to the embodiment are, it is preferable, properly adopted.

In step S101, the monitoring device 1 detects the device connected to the base-point network 8. The device detecting unit 101 of the monitoring device 1 monitors a connected status of the target device 3 to the base-point network 8 and detects the connection of the target device 3 to the base-point network 8. A variety of existing methods may be adopted as a method of detecting the target device 3. For example, the monitoring device 1 reads ARP (Address Resolution Protocol) query packets transmitted from the target devices 3, and detects MAC (Media Access Control) addresses of the devices within the base-point network 8, thereby enabling a target device 3 newly connected to the base-point network 8 to be detected.

IEEE802.3 generally used for building up the base-point network 8 requires the MAC address of the communication partner device in order to perform the communications. A case of performing the communications with devices outside the base-point network 8 also entails a MAC address of a router (which is the monitoring device 1 in the embodiment) serving as an egress point to an external network. In an environment of IPv4 (Internet Protocol version 4) that is broadly utilized at the present, the ARP is used for acquiring the MAC address of the communication partner device. According to the ARP, a query for obtaining the MAC address of the device having a target IP address is transmitted (i.e., broadcasted) to all of the devices within the network segment, and has an entry of the MAC address and the IP address of the sender device. Therefore, the monitoring device 1 detects the MAC address of the device within the base-point network 8 and the IP address associated with the MAC address by reading this packet and can thus detect the target device 3 newly connected to the base-point network 8.

Note that an environment of IPv6 (Internet Protocol version 6) provides a mechanism called “Neighbor Discovery” for obtaining the MAC address of the communication partner device, in which a query is transmitted (broadcasted) to all of the devices which support the IPv6 within the network segment. Therefore, in the IPv6 environment also, the monitoring device 1 detects the MAC address and the IP address by referring to the transmitted query similarly to the case of the IPv4 environment, and can detect the target device 3 newly connected to the base-point network 8.

Further, identification of the target device 3 to be detected may involve using any one of the IP address, the host name and the MAC address. Note that the MAC address is allocated uniquely in general except a virtual device and is therefore suited to the identification of the target device 3. Upon detecting the device connected to the base-point network 8, the processing proceeds to step S102.

In step S102, the device type of the detected device is determined. When the target device 3 connected to the base-point network 8 is detected, the device type determining unit 103 acquires the various items of information on the target device 3 and determines, based on the acquired information, the device type of the target device 3. The power consumption quantity estimation system 100 according to the embodiment estimates a tendency of the power consumption of the target device 3 according to the device type determined herein.

Multiple methods can be adopted for determining the device type of the detected target device 3. The discussion starts with touching a method of determining the device type by use of the query about the target device 3. For example, the device type determining unit 103 acquires, as to the information obtainable from a direct query, the information by giving the direct query to the target device 3 from the monitoring device 1, and thus determines the device type of the target device 3. It is feasible to acquire the various items of device information containing hardware information of the target device 3 that supports SNMP (Simple Network Management Protocol) by obtaining MIB (Management Information Base) information held by the target device 3.

Next, a method of presuming the device type by analyzing the communication content, will be discussed. In the devices connected to the base-point network 8, there are some devices that neither support the management protocol such as SNMP nor can acquire, even when supporting to the protocol, the information directly specifying the device type from outside. In the embodiment, the device type determining unit 103 presumes, with respect to the target device 3 disabled from acquiring the information specifying the device type through the direct query, the device type by analyzing the communication content related to the target device 3. The communication acquiring unit 102 reads the communications transmitted and received by the target device 3, and the device type determining unit 103 extracts the information on the target device 3 from the communication content, thereby determining the device type of the target device 3. For example, in HTTP (HyperText Transfer Protocol) used for Web access, SIP (Session Initiation Protocol) utilized for IP telephony and NetBIOS over TCP/IP (NBT) used in Window® OS, the communication content contains items of information on the type of the target device 3 and the OS, and hence the device type of the target device 3 can be determined by extracting these items of information from the communication content.

In the embodiment, the monitoring device 1 is connected between the base-point network 8 and the network 9 and performs a role as a router. The monitoring device 1 may not, however, include the function as the router. It is preferable that an option of whether the monitoring device 1 is configured as a device dedicated to monitor the network or a device serving for other functions as the router etc, is properly determined corresponding to the embodiment. The communication acquiring unit 102 applies a filter to a broadcast packet, a unicast packet and a multicast packet addressed to the monitoring devices 1 which are received by the monitoring devices 1 and the packets passing through the monitoring devices 1, thus identifying the communication from which the information on the target device 3 can be extracted. Specifically, the communication, from which the information on the target device 3 can be extracted, can be identified through the filter using a port number based on TCP/UDP (Transfer Control Protocol/User Datagram Protocol). For instance, NBT (UDP destination port number 138), mDNS (multicast Domain Name System, UDP destination port number 5353), SIP (UDP destination port number 5060), DHCP (Dynamic Host Configuration Protocol, UDP destination port number 67), LLMNR (Link-Local Multicast Name Resolution, UDP destination port number 5355) and HTTP (TCP destination port number 80) are set in the filter, whereby the communication, from which the information on the target device 3 can be extracted, can be identified from within the communications passing though the monitoring device 1.

When the communication is identified by use of the filter, the device type determining unit 103 extracts the information on the target device 3 from the communication content, thereby determining the device type of the target device 3. For example, in the case of acquiring the NBT-based communication, the device type of the target device 3 can be determined by referring to a “Major Version/Minor Version” field and a “Server Type” field in Browser Host Announcement. Further, in the case of acquiring the HTTP-based communication, the device type of the target device 3 can be determined by referring to a “User-Agent” field contained in a header of a GET packet. In the case of acquiring the mDNS-based communication, the device type of the target device 3 can be determined by referring to a “Resource Data” field.

Next, a method of presuming the device type based on a communication characteristic will hereinafter be described. In the target devices 3, there is a possibility of existences of some target devices 3 disabled from extracting the information out of the communication content for the reason that the target device 3 does not perform the communication containing the information about the type of the target device 3 and the OS as described above and, even when performing the communication, the communication content is encrypted, and so on. In the embodiment, even in such a case, the device type of the target device 3 is determined (presumed) based on the communication characteristic of the target device 3 in the base-point network 8. For example, the device type determining unit 103 presumes the device type of the target device 3 by determining a type of the communication acquired by the communication acquiring unit 102. To be specific, the device type determining unit 103 determines the type of the communication from the port number used for the communication by the target device 3, thereby enabling the device type of the target device 3 to be presumed.

To give a more specific example, in the case of acquiring the SIP-based communication, the device type of the device, which transmits REQUEST or a STATUS request, can be determined to be an IP telephone. Further, in the case of acquiring the DHCP-based communication, the device type of the target device 3 can be presumed by analyzing a characteristic of Option code. This is because a description mode of the Option code has a characteristic for every type of the OS.

Moreover, the device type determining unit 103 tries to perform the communication with the target device and may determine (presume) the device type of the target device 3 on the basis of a response (the communication characteristic) to this communication. For instance, the device type determining unit 103 tries to establish the TCP-based communication (establish the connection) with a predetermined port number of the target device 3 and can presume, based on a result of this connection (whether the connection is established or not), the device type of the target device 3. For example, when the predetermined port number is opened (the connection can be established), the device type of the target device 3 can be presumed to be a printer. With respect to this type of communication trial, the communication may be periodically retried in a way that takes a startup time zone of the target device 3 into consideration.

Further, UPnP (Universal Plug and Play) and the mDNS enable a search for the target device 3 within the network segment for providing specified functions and services. Other available methods are a method of presuming the device type from a response content given by transmitting the HTTP-based GET request to the target device 3, a method of determining the device type by acquiring the device information in a way that uses the UPnP and searches for the device supporting the UPnP, and so on.

Explained next is a method of presuming the device type on the basis of the MAC address of the target device 3. The device type determining unit 103 can presume, based on the MAC address of the target device 3, the device type of the target device 3. The device type determining unit 103 specifies a vendor of the target device 3 by referring to a vendor code (Vendor ID field) in the MAC address. Further, in the case of setting an allocation range corresponding to the device type etc in the Vendor with respect to a field other than the vendor code in the MAC address, the device type determining unit 103 can also presume the device type from a value given in the field other than the vendor code by referring to this allocation rule. Moreover, the device type determining unit 103 can acquired the device type by making a Web search using a model number obtained in the MIB and the MAC address. In this case, the device type determining unit 103 may further acquire a catalog value of the power consumption in addition to the device type.

Note that the device type determining unit 103, after detecting the target device 3, sets the detected target device 3 in a [device type now-being-determined] status, and determines the device type by using a plurality of device type determination methods described above in a multiple mode. In this case, because of the plurality of device type determination methods being applied, the device type determining unit 103 manages by using a flag whether the determination is made by each of the device type determination methods (e.g., “true” is set in the already-tried device type determination method, while “false” is set in the not-yet-tried device type determination method), and deems the process as an [end of device type determination] if a fixed period of time (e.g., 24 hrs.) elapses or if all of the flags become “true” (all of the device type determination methods have already been tried), thus setting the device type.

Furthermore, as a result of applying the plurality of device type determination methods, a case to be considered is that the determination result of the device type determination method applied later is different from the determination result of the device type determination method applier earlier. In this case, the device type determining unit 103 compares, in order to obtain a more accurate determination result of the device type, the different determination results with each other, and adopts, only in a predetermined case, the determination result of the device type determination method applied later. For instance, the device type determining unit 103 presets relative priority levels among the device types and can, if the device type exhibiting a higher priority level is acquired as the result of the determination, adopt this determination result. Further, the device type determining unit 103 presets a level of the accuracy for every device type determination method, and can adopt the determination result of the device type determination method having a higher level of accuracy.

Moreover, in the embodiment, after the device type has been once set, the device type is not redetermined. If the device type is a router/switch, however, it is preferable that the device type is reset (returned to “unknown”) when the IP address is changed. Upon determining the device type of the target device 3, the processing proceeds to step S103.

In step S103, the monitoring device 1 collects the operating statuses of the target devices 3. The operating status acquiring unit 104, with respect to the target devices 3 undergoing the detection and the determination of the device type in steps S101 and S102, continuously acquires the operating statuses of the target devices 3, thus collecting the operating status(es) of the single or the plurality of target devices 3 connected to the base-point network 8. The power consumption quantity estimation system 100 according to the embodiment estimates the tendency of the power consumption of the target devices 3 in accordance with the operating statuses acquired herein. Therefore, the operating status is, it is preferable, the information indicating at least whether the target device 3 operates or not. The operating status may, however, contain information indicating whether the target device 3 operates in a (high-load) status with a large quantity of power consumption or in a (low-load) status with a small quantity of power consumption.

Note that the acquisition of the specific operating status can involve adopting a variety of methods similarly to when determining the device type in step S102. The discussion will begin with a method of acquiring the operating status by giving the query to the target device 3. For example, the operating status acquiring unit 104, with respect to the information obtainable through the SNMP-based direct query, acquires the information by giving the direct query to the target device 3 from the monitoring device 1, thereby acquiring the operating status of the target device 3. As for the target device 3 that supports the SNMP, it is feasible to acquire the operating status of the target device 3 by obtaining the MIB information held by the target device 3. Further, the monitoring device 1 can also acquire the operating status of the target device 3 by analyzing a response status to “ping” transmitted to the target device 3 from the monitoring device 1.

Next, a method of acquiring the operating status by analyzing the communication content and the communication state will be discussed. The devices connected to the base-point network 8 include the devices that do not support the management protocol such as the SNMP, the devices of which, even when supporting the management protocol, the operating statuses can not be acquired from outside, and the devices that do not respond to “ping” for the reason in terms of the security etc. In the embodiment, the operating status acquiring unit 104 presumes and acquires the operating status of the target device 3, of which the operating status can not be acquired through the direct query, by analyzing the communication content and the communication state related to this target device 3.

Herein, the communication acquiring unit 102 reads the communication transmitted and received by the target device 3. In the embodiment, the monitoring device 1 is connected between the base-point network 8 and the external network, and the communication between the target device 3 and the external network passes through the monitoring device 1 and can therefore be acquired. Further, with respect to the communication of the target device 3 within the base-point network 8, the communication related to the target device 3 can be acquired by a method such as acquiring the broadcast packet or the multicast packet, guiding the communication in a way that masquerades the MAC address of the communication partner device with the target device 3 with the MAC address of the monitoring device 1 and acquiring all of the packets reaching the port of the monitoring device 1 (which include the packet in which the MAC address of another device is set in the “destination” field) by operating a network interface 16 of the monitoring device 1 in a promiscuous mode.

The operating status acquiring unit 104 presumes and acquires the operating status of the target device 3 from the communication content and the communication state by analyzing the communication acquired by the communication acquiring unit 102. For instance, the operating status acquiring unit 104, if the communication acquiring unit 102 acquires the communication transmitted by the target device 3 as a sender device, can presume the operating status of the sender target device 3 as an [in-operation] status. Further, e.g., the operating status acquiring unit 104 can presume the operating status of the target device 3 from the port number used for the communication by the target device 3. Moreover, the operating status acquiring unit 104 presumes a magnitude of load on the target device 3 on the basis of the communication quantity (traffic) and the communication content related to the target device 3, which are acquired by the communication acquiring unit 102, and can presume, based on the presumed magnitude of load, the operating status of the target device 3 as an [in-operation with high load] or [in-operation with low load] status. More specifically, the operating status acquiring unit 104 presumes the magnitude of load on the target device 3 and can acquire the operating status corresponding to the magnitude of load by a method of comparing the quantity of the communication related to the target device 3 with a preset threshold value, and so on.

Furthermore, if the target device 3, which has responded to the SNMP-based direct query and “ping” so far, does not respond and if the communication acquiring unit 102 does not acquire for a predetermined or longer period of time the communication related to the target device 3 of which the operating status is presumed by analyzing the communication content and the communication state, the operating status acquiring unit 104 can presume the operating status of the target device 3 as a [non-operation] status.

When the operating status is acquired by the operating status acquiring unit 104, the operating time acquiring unit 105 acquires a period of operating time, on a per-operating-status basis, of the target device 3. The operating time acquiring unit 105, with respect to the target device 3 of which the operating time can be acquired on the per-operating-status basis through the SNMP-based direct query etc, acquires the operating time on the per-operating-status basis according to a result of the query.

Further, the operating time acquiring unit 105, with respect to the target device 3 of which the operating status can not be obtained through the direct query, acquires the operating time per operating status of the target device 3 on the basis of the time when the operating status acquiring unit 104 has acquired the operating status. The target device 3 is said to be in the operating status leastwise at the time when the operating status acquiring unit 104 acquires the operating status. Therefore, the operating time acquiring unit 105, e.g., if the operating status different from the operating status acquired last time is obtained, assumes that the operating status acquired last time continues up to a fixed period of time before when the different operating status was acquired and that the operating time of the newly-acquired operating status starts from the fixed period of time before when the different operating status was acquired, and can presume an end point and a start point of the operating time of the operating status before and after the operating status changes.

The operating time acquiring unit 105 of the monitoring device 1 installed in each base-point network totalizes, the periods of operating time on the per-operating-status basis of the target devices 3 periodically (e.g., at an interval of one day), when collecting items of identifying information (the MAC address, the IP address, the host name, etc), the device types and the operating statuses. Then, the information transmitting unit 106 of the monitoring device 1 installed in each base-point network transmits the collected items of information such as the identifying information (the MAC address, the IP address, the host name, etc), the device types, the operating statuses and the periods of operating time on the per-operating-status basis of the target devices 3 to the information aggregation server periodically (e.g., at the interval of one day). The information receiving unit 202 of the information aggregation server device 2 receives the identifying information, the device types, the operating statuses and the operating time of the target devices 3, which are transmitted by the information transmitting unit 106 of the monitoring device 1. The received items of information are accumulated in the way of being associated with each other in the operation information database 4.

If the device is disconnected from a certain base-point network and immediately connected to another base-point network, however, a possibility is that the new connection of the target device 3 to another base-point network might be detected earlier than detecting an operation stop (non-operation) of the device in the base-point network from which the device is disconnected. Therefore, the information aggregation server device 2, in order to avoid setting, as the non-operation status, the operating status of the in-operation target device 3, in the case of detecting the operation stop (non-operation) of the target device 3 in the base-point network other than the base-point network where the target device 3 was finally detected, may not accumulate the operating status related to this target device 3 in the operation information database 4. When the operating statuses of the target devices 3 are collected and accumulated in the operation information database 4, the processing proceeds to step S104.

In step S104, the estimated power consumption quantity is calculated. The estimated power consumption quantity calculating unit 204 calculates, periodically or upon receiving an instruction to calculate the power consumption quantity from the user, the estimated power consumption quantity per target device 3 by use of the power consumption coefficient retained in the device information database 5 in a way that reads the device type, the operating status and the operating time from the operation information database 4.

To be more specific, the estimated power consumption quantity calculating unit 204 reads the device type, the operating status and the operating time per operating status of the target device 3 connected to the base-point network 8 for a preset period or a period designated by the user. Then, the power consumption coefficient acquiring unit 203 reads, based on the readout information, the device type and a power consumption coefficient per operating status from the device information database 5. Namely, the power consumption coefficient acquiring unit 203 acquires the power consumption coefficient from the power consumption coefficient retaining unit 201 according to the device type (e.g., the PC, the server, the network printer, the network scanner, the KIOSK terminal, the IP telephone, etc) of the target device 3 that is determined by the device type determining unit 103 and the operating status (e.g., the [in-operation] status, the [non-operation] status, the [in-operation with high load] status, the [in-operation with low load] status, etc) of the target device 3 that is acquired by the operating status acquiring unit 104.

The estimated power consumption quantity calculating unit 204 calculates, per target device 3, the power consumption quantity during a target period by multiplying the power consumption coefficient per operating status during the target period for calculating the power consumption quantity by the operating time per operating status during the target period. Note that the target period for calculating the power consumption quantity is previously set or designated by the user via the input device or the administrator terminal, and retained in the auxiliary storage device 29. The target period may be set to an arbitrary period such as one day, one week and one month. Herein, if the plurality of operating statuses (e.g., a time zone in the in-operation status, a time zone in the non-operation status, a time zone in the in-operation-with-high-load status and a time zone in the in-operation-with-low-load status) exists in the target period, the power consumption quantity during the target period is calculated by totalizing the power consumption quantities calculated on the per-operating-status basis. More specifically, the estimated power consumption quantity calculating unit 204 calculates (estimates) the power consumption quantity per target device 3 by executing an arithmetic process of the following formula 1. Note that the following formula 1 provides the calculation method in such a case that three types of operating statuses A through C are given to the target device 3 as a calculation target device.

Power Consumption Quantity during Target Period=Power Consumption Coefficient in Operating Status A*Operating Time in Operating Status A+Power Consumption Coefficient in Operating Status B*Operating Time in Operating Status B+Power Consumption Coefficient in Operating Status C*Operating Time in Operating Status C Formula 1

When calculating the power consumption quantity per target device 3 during the target period, the estimated power consumption quantity totalizing unit 205 totalizes the calculated power consumption quantities per target device 3, thereby calculating the estimated power consumption quantity in the base-point network 8. Further, the estimated power consumption quantity totalizing unit 205 may further calculate a total of the estimated power consumption quantities in the plurality of base-point networks by totalizing the estimated power consumption quantities in the plurality of base-point networks.

When calculating the estimated power consumption quantity per target device 3, the estimated power consumption quantity in the base-point network 8 and the total of the estimated power consumption quantities in the plurality of base-point networks, the information aggregation server 2 outputs the calculation results to the auxiliary storage device 29, the input/output device and the administrator terminal. Upon finishing calculating and outputting the estimated power consumption quantities, the processes given in the flowchart are finished.

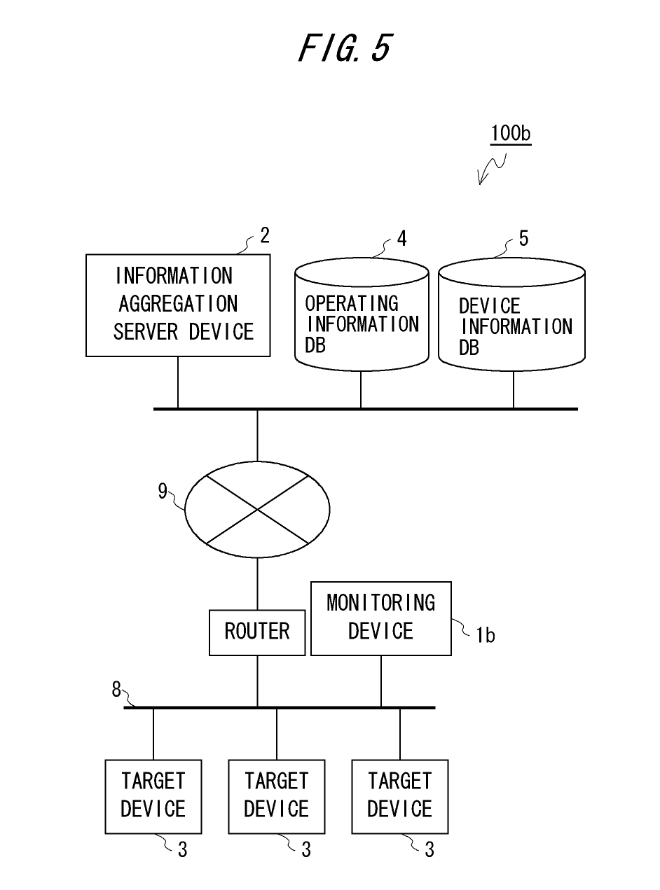

FIG. 5 is a diagram illustrating a whole configuration of a power consumption quantity estimation system 100b according to another embodiment. The embodiment described above has discussed the case in which the monitoring device 1 serving as the router is connected between the base-point network 8 and the network 9, however, the monitoring device is not necessarily connected between the base-point network 8 and the network 9. An example illustrated in FIG. 5 is that a monitoring device 1b is connected to the network 8 similarly to other target devices 3 participating in the base-point network 8. Even in such a case, the monitoring device can acquire the communication related to the target device 3 by the method such as acquiring the broadcast packet or the multicast packet, guiding the communication in a way that masquerades the MAC address of the communication partner device with the target device 3 with the MAC address of the monitoring device, and acquiring all of the packets reaching the port of the monitoring device by operating the network interface 16 of the monitoring device in the promiscuous mode.

The power consumption quantity estimation system according to the embodiment can, with respect to the devices of which the information indicating the device types can not be acquired from outside and the devices of which the operating statuses can not be acquired from outside, calculate and collect the power consumptions of the target devices 3 by installing neither any special sensor for measuring the power consumption nor special software.

What is claimed is:

1. A power consumption quantity estimation system comprising:
a power consumption coefficient retaining unit to previously retain a power consumption coefficient indicating a level of power consumption per operating status of a device;
a communication acquiring unit to acquire a communication related to said device connected to a network;
an operating status acquiring unit to acquire the operating status of said device by analyzing the communication acquired by said communication acquiring unit;
a power consumption coefficient acquiring unit to acquire the power consumption coefficient, related to the operating status, of said device in the power consumption coefficients retained by said power consumption coefficient retaining unit; and
an estimated power consumption quantity calculating unit to calculate estimated power consumption quantity of said device during a target period by use of the power consumption coefficient per operating status during the target period for calculating the power consumption quantity.

2. A power consumption quantity estimation system according to claim 1, further comprising an operating time acquiring unit to acquire operating time, per operating status, of said device,
wherein said estimated power consumption quantity calculating unit calculates the estimated power consumption quantity of said device during the target period by use of the power consumption coefficient per operating status during the target period and the operating time per operating status during the target period.

3. A power consumption quantity estimation system according to claim 2, wherein the power consumption coefficient is a power consumption quantity, per unit time related to the operating status, of said device, and
said estimated power consumption quantity calculating unit calculates the estimated power consumption quantity of said device during the target period by multiplying the power consumption coefficient per operating status during the target period by the operating time per operating status during the target period.

4. A power consumption quantity estimation system according to claim 1, further comprising: a device detecting unit to detect said device connected to the network; and a device type determining unit to determine the device type of said detected device,
wherein said power consumption coefficient retaining unit previously retains the power consumption coefficient per operating status on a per-device-type basis, and
said power consumption coefficient acquiring unit acquires the power consumption coefficient, related to the operating status, of said device in accordance with the device type of said device that is determined by said device type determining unit.

5. A power consumption quantity estimation system according to claim 4, wherein said device type determining unit determines the device type of said device detected by said device detecting unit in a way that extracts information on said device that is contained in the communication acquired by said communication acquiring unit or determines a type of the communication acquired by said communication acquiring unit.

6. A power consumption quantity estimation system according to claim 1, wherein said estimated power consumption quantity calculating unit calculating the estimated power consumption quantity per device with respect to said plurality of devices connected to the network, and
the power consumption quantity estimation system further comprising: an estimated power consumption quantity totalizing unit to calculate a total of the estimated power consumption quantities of said devices connected to the network by totalizing the estimated power consumption quantities per device, which are calculated by said estimated power consumption quantity calculating unit.

7. A power consumption quantity estimation system according to claim 1, wherein said operating status acquiring unit, when said communication acquiring unit acquires the communication of said device as a sender device, acquires the operating status indicating that said device is in operation.

8. A power consumption quantity estimation system according to claim 1, wherein said operating status acquiring unit acquires the operating status containing a magnitude of load on said device corresponding to a communication quantity or a communication content of the communication related to said device that is acquired by said communication acquiring unit, and
said power consumption coefficient acquiring unit acquires the power consumption coefficient corresponding to the magnitude of load, related to the operating status, of said device.

9. An information processing device connected to a server device including: a power consumption coefficient retaining unit to previously retain a power consumption coefficient indicating a level of power consumption per operating status of a device; a power consumption coefficient acquiring unit to acquire the power consumption coefficient, related to the operating status, of said device in the power consumption coefficients retained by said power consumption coefficient retaining unit; and an estimated power consumption quantity calculating unit to calculate estimated power consumption quantity of said device during a target period by use of the power consumption coefficient per operating status during the target period for calculating the power consumption quantity, said information processing device comprising:
a communication acquiring unit to acquire a communication related to said device connected to a network;
an operating status acquiring unit to acquire the operating status of said device by analyzing the communication acquired by said communication acquiring unit; and
a transmitting unit to transmit the operating status acquired by said operating status acquiring unit to said server device.

10. An information processing device according to claim 9, wherein said operating status acquiring unit acquires, when said communication acquiring unit acquires the communication of said device as a sender device, the operating status indicating that said device is in operation.

11. An information processing device according to claim 9, wherein said operating status acquiring unit acquires the operating status containing a magnitude of load on said device corresponding to a communication quantity or a communication content of the communication related to said device that is acquired by said communication acquiring unit, and
said power consumption coefficient acquiring unit acquires the power consumption coefficient corresponding to the magnitude of load, related to the operating status, of said device.

12. An information processing device according to claim 9, further comprising: a device detecting unit to detect said device connected to the network; and a device type determining unit to determine the device type of said detected device,
wherein said transmitting unit further transmits the device type determined by said device type determining unit to said server device and gets said power consumption coefficient acquiring unit of said server device to acquire the power consumption coefficient related to the operating status of said device according to the device type.

13. An information processing device according to claim 12, wherein said device type determining unit determines the device type of said device detected by said device detecting unit in a way that extracts information on said device that is contained in the communication acquired by said communication acquiring unit or determines a type of the communication acquired by said communication acquiring unit.

14. A server device connected to an information processing device including: a communication acquiring unit to acquire a communication related to said device connected to a network; and an operating status acquiring unit to acquire the operating status of said device by analyzing the communication acquired by said communication acquiring unit, said server device comprising:
a receiving unit to receive the operating status acquired by said operating status acquiring unit from said information processing device;
a power consumption coefficient retaining unit to previously retain a power consumption coefficient indicating a level of power consumption per operating status of a device;
a power consumption coefficient acquiring unit to acquire the power consumption coefficient, related to the operating status, of said device in the power consumption coefficients retained by said power consumption coefficient retaining unit; and
an estimated power consumption quantity calculating unit to calculate estimated power consumption quantity of said device during a target period by use of the power consumption coefficient per operating status during the target period for calculating the power consumption quantity.

15. A readable-by-computer recording medium recorded with a program to make an information processing device connected to a server device including: a power consumption coefficient retaining unit to previously retain a power consumption coefficient indicating a level of power consumption per operating status of a device; a power consumption coefficient acquiring unit to acquire the power consumption coefficient, related to the operating status, of said device in the power consumption coefficients retained by said power consumption coefficient retaining unit; and an estimated power consumption quantity calculating unit to calculate estimated power consumption quantity of said device during a target period by use of the power consumption coefficient per operating status during the target period for calculating the power consumption quantity, execute:
acquiring a communication related to said device connected to a network;
acquiring the operating status of said device by analyzing the communication acquired in said communication acquiring; and
transmitting the operating status acquired in said acquiring the operating status to said server device.

16. A readable-by-computer recording medium recorded with a program to make a server device connected to an information processing device including: a communication acquiring unit to acquire a communication related to said device connected to a network; and an operating status acquiring unit to acquire the operating status of said device by analyzing the communication acquired by said communication acquiring unit, execute:
receiving the operating status acquired by said operating status acquiring unit from said information processing device;
previously retaining a power consumption coefficient indicating a level of power consumption per operating status of a device;
acquiring the power consumption coefficient, related to the operating status, of said device in the power consumption coefficients retained in said retaining; and
calculating estimated power consumption quantity of said device during a target period by use of the power consumption coefficient per operating status during the target period for calculating the power consumption quantity.
